(19) United States
(12) Patent Application Publication
(10) Pub. No.: US 2023/0018467 A1
(43) Pub. Date: Jan. 19, 2023

(54) SUPPORT SERVER, DISASTER SUPPORT SYSTEM, AND STORAGE MEDIUM

(71) Applicant: TOYOTA JIDOSHA KABUSHIKI KAISHA, Toyota-shi (JP)

(72) Inventors: Yusuke HOKI, Mishima-shi (JP); Koseki SUGIYAMA, Sunto-gun (JP); Kumiko KATSUMATA, Susono-shi (JP); Rie YAYABE, Sunto-gun (JP); Shin SAKURADA, Toyota-shi (JP); Tomio YAMANAKA, Nagoya-shi (JP)

(73) Assignee: TOYOTA JIDOSHA KABUSHIKI KAISHA, Toyota-shi (JP)

(21) Appl. No.: 17/750,605

(22) Filed: May 23, 2022

(30) Foreign Application Priority Data
Jul. 14, 2021 (JP) 2021-116477

(51) Int. Cl. B60L 55/00; G06Q 50/06; G05B 19/042; G01C 21/34; B60L 53/63; B60L 53/66

(52) U.S. Cl. CPC B60L 55/00; B60L 53/63; B60L 53/665; G01C 21/3469; G05B 19/042; G06Q 50/06; G06Q 20/36

(57) ABSTRACT

A support server includes a processor configured to: acquire a total supply power amount from each of a plurality of facilities placed within a stricken area, the total supply power amount being obtained by adding respective supply power amounts of a plurality of power supply vehicles configured to perform power supply; acquire, from at least one vehicle placed within the stricken area, a supply power amount suppliable by the at least one vehicle; and output, to at least either one of the at least one vehicle and a communications device associated with the at least one vehicle, request facility information on a request facility that requires to request power supply due to a shortage of electric power, based on respective total supply power amounts of the facilities and the supply power amount suppliable by the at least one vehicle.

### CROSS-REFERENCE TO RELATED APPLICATION

This application claims priority to Japanese Patent Application No. 2021-116477 filed on Jul. 14, 2021, incorporated herein by reference in its entirety.

### BACKGROUND

### 1. Technical Field

This disclosure relates to a support server, a disaster support system, and a storage medium.

### 2. Description of Related Art

Japanese Unexamined Patent Application Publication No. 2020-114051 (JP 2020-114051 A) describes the following technology. That is, when a disaster occurs or the occurrence of a disaster is predicted, a predetermined facility is assigned to a vehicle that can supply electric power to outside, and position information on the facility thus assigned is transmitted to the vehicle, so that electric power is supplied from the vehicle to the facility.

### SUMMARY

However, JP 2020-114051 A does not consider necessary electric power to be necessary in the facility assigned to the vehicle and supply electric power suppliable by the vehicle. Accordingly, in JP 2020-114051 A, the electric power to be supplied from the vehicle to the facility exceeds the necessary electric power or goes below the necessary electric power. Accordingly, it is difficult to maintain a balance between the amount of the necessary electric power in the facility and the supply electric power suppliable by the vehicle.

This disclosure is accomplished in view of the above problem, and an object of this disclosure is to provide a support server, a disaster support system, and a storage medium each of which can maintain a balance between necessary electric power in a facility and supply electric power suppliable by a vehicle.

A support server according to this disclosure includes a processor configured to: acquire a total supply power amount from each of a plurality of facilities placed within a stricken area, the total supply power amount being obtained by adding respective supply power amounts of a plurality of power supply vehicles configured to perform power supply; acquire, from at least one vehicle placed within the stricken area, a supply power amount suppliable by the at least one vehicle; and output, to at least either one of the at least one vehicle and a communications device associated with the at least one vehicle, request facility information on a request facility that requires to request power supply due to a shortage of electric power, based on respective total supply power amounts of the facilities and the supply power amount suppliable by the at least one vehicle.

Further, a disaster support system according to this disclosure includes a plurality of power supply vehicles, at least one vehicle, and a support server. The power supply vehicles are configured to perform power supply to each of a plurality of facilities within a stricken area. The at least one vehicle is placed within the stricken area. The support server is communicable with each of the power supply vehicles and the at least one vehicle. The support server includes a processor configured to: acquire a total supply power amount from each of the facilities, the total supply power amount being obtained by adding respective supply power amounts of the power supply vehicles; acquire, from the at least one vehicle, a supply power amount suppliable by the at least one vehicle; and output, to at least either one of the at least one vehicle and a communications device associated with the at least one vehicle, request facility information on a request facility that requires to request power supply due to a shortage of electric power, based on respective total supply power amounts of the facilities and the supply power amount suppliable by the at least one vehicle.

Further, a storage medium according to this disclosure stores a program causes a support server to execute the followings: acquiring a total supply power amount from each of a plurality of facilities placed within a stricken area, the total supply power amount being obtained by adding respective supply power amounts of a plurality of power supply vehicles configured to perform power supply; acquiring, from at least one vehicle placed within the stricken area, a supply power amount suppliable by the at least one vehicle; and outputting, to at least either one of the at least one vehicle and a communications device associated with the at least one vehicle, request facility information on a request facility that requires to request power supply due to a shortage of electric power, based on respective total supply power amounts of the facilities and the supply power amount suppliable by the at least one vehicle.

With this disclosure, it is possible to yield an effect to maintain a balance between necessary electric power in a facility and supply electric power suppliable by a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view illustrating a schematic configuration of a disaster support system according to one embodiment;

FIG. 2 is a block diagram illustrating a functional configuration of a vehicle according to one embodiment;

FIG. 3 is a block diagram illustrating a functional configuration of a support server according to one embodiment; and

FIG. 4 is a flowchart illustrating the outline of a process to be executed by the support server according to one embodiment.

### DETAILED DESCRIPTION OF EMBODIMENTS

The following describes a support server, a disaster support system, and a program according to an embodiment of this disclosure with reference to the drawings. Note that this disclosure is not limited to the following embodiment. Further, in the following description, the same element has the same reference sign.

### Schematic Configuration of Disaster Support System

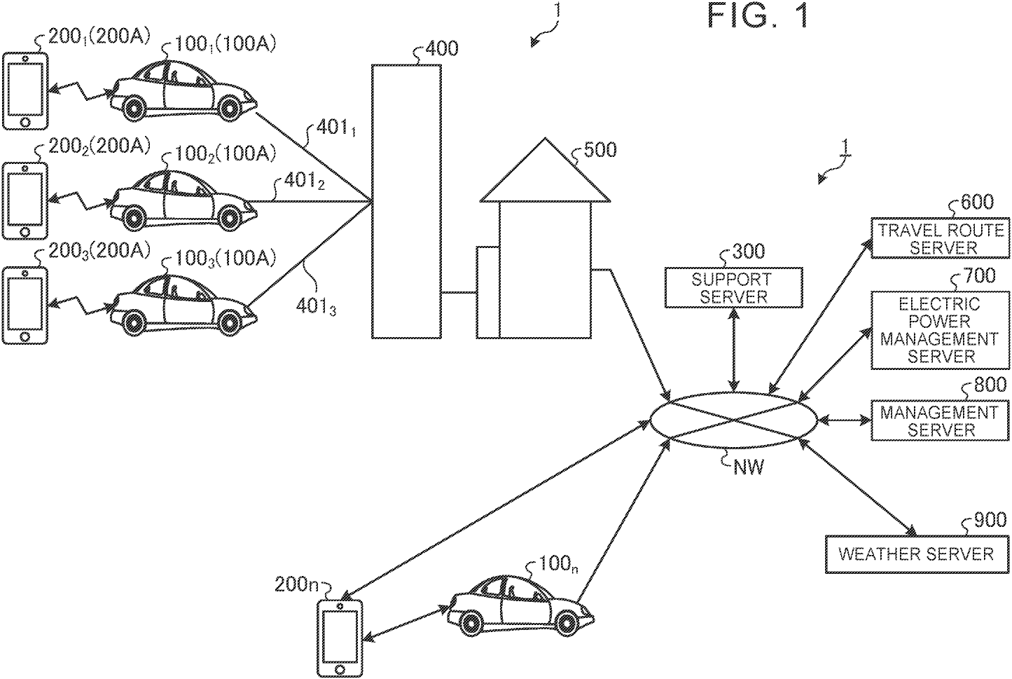

FIG. 1 is a view illustrating a schematic configuration of a disaster support system according to one embodiment. A disaster support system 1 illustrated in FIG. 1 includes a plurality of vehicles 100₁ to 100ₙ (n = an integer of 4 or more), communications devices 200₁ to 200ₙ, a support server 300, a charge-discharge apparatus 400, a facility 500, a travel route server 600, an electric power management server 700, a management server 800, and a weather server 900. Note that a network NW illustrated in FIG. 1 is constituted by an Internet network, a mobile phone network, or the like, for example.

Each of the vehicles 100₁ to 100ₙ is achieved by use of any of a hybrid electric vehicle (HEV), a plug-in hybrid electric vehicle (PHEV), a fuel cell electric vehicle (FCEV), and a battery electric vehicle (BEV). In the following description, in a case where any of the vehicles 100₁ to 100ₙ is mentioned, it is merely described as a “vehicle 100.” Further in the following description, the vehicle 100 that supplies electric power to the facility 500 via the charge-discharge apparatus 400 among the vehicles 100₁ to 100ₙ is just referred to as a “power supply vehicle 100A.” Note that a detailed configuration of the vehicle 100 will be described later.

The communications devices 200₁ to 200ₙ can communicate with their corresponding vehicles 100 in accordance with a predetermined communications standard and can also communicate with the support server 300, the travel route server 600, and the electric power management server 700 via the network NW. Here, the predetermined communications standard is at least either one of Bluetooth (registered trademark) and Wi-Fi (registered trademark). The communications device 200 is constituted by use of a mobile phone, a tablet-type communication terminal, or the like, for example. Note that, in the following description, in a case where any of the communications devices 200₁ to 200ₙ is mentioned, it is merely described as a “communications device 200.” Further, in the following description, among the communications devices 200₁ to 200ₙ, the communications device 200 associated with the power supply vehicle 100A is merely described as a “communications device 200A.”

The support server 300 can communicate with the vehicles 100, the communications devices 200, the facility 500, the travel route server 600, the electric power management server 700, and the management server 800 via the network NW and acquires information necessary to support users at the time of a disaster. Note that a detailed configuration of the support server 300 will be described later.

The charge-discharge apparatus 400 electrically connects the facility 500 to the vehicles 100₁ to 100₃ connected in parallel via respective charge-discharge wires 401₁ to 401₃. The charge-discharge apparatus 400 converts electric power supplied from the facility 500 into electric power with a predetermine voltage and supplies it to the vehicles 100₁ to 100₃ connected in parallel via the respective charge-discharge wires 401₁ to 401₃. Further, the charge-discharge apparatus 400 converts electric power supplied from each of the vehicles 100₁ to 100₃ connected in parallel via the respective charge-discharge wires 401₁ to 401₃ into electric power with a predetermine voltage and supplies it to the facility 500.

The facility 500 receives electric power supplied from each of the vehicles 100₁ to 100₃ via the charge-discharge apparatus 400 and also receives commercial system electric power from a power line or the like. Further, the facility 500 supplies electric power to the vehicles 100₁ to 100₃ via the charge-discharge apparatus 400. The facility 500 is a commercial facility, a school, a hospital, a public facility such as a city hall, a gymnasium, a camp site, an emergency facility, or the like. Note that, in order to simplify the description, FIG. 1 deals with a case where one charge-discharge apparatus 400 and one facility 500 are provided. However, a plurality of charge-discharge apparatuses 400 and a plurality of facilities 500 are placed within a predetermined stricken area (e.g., 100 km × 100 km).

The travel route server 600 manages, in association with map data, travel routes (passable roads) usable by the vehicles 100 and travel routes not usable by the vehicles 100, based on probe information acquired from each of the vehicles 100 or controller area network (CAN) data acquired from each of the vehicles 100.

The electric power management server 700 manages an electric-power supply state in each predetermined area and a contract demand of each facility 500 via the network NW. For example, the electric power management server 700 manages an electric-power supply state of a stricken area where power outage has occurred, and a contract demand of each facility 500 in the stricken area.

The management server 800 manages a plurality of different payment methods associated with the communications device 200 via the network NW, the different payment methods being managed by respective companies and registered in a digital wallet showing a deposit-withdrawal account for electronic money or points.

The weather server 900 can communicate with the vehicle 100 and the communications device 200 via the network NW and outputs weather information corresponding to position information on the vehicle 100 or the communications device 200. Here, the weather information includes abnormal weather, disaster warning information, disaster prevention information, and so on. Further, the abnormal weather is a weather based on a warning given by disasters such as torrential rain, heavy rain, typhoon, heavy snow, strong wind, storm, landslide, volcano, storm surge, flood, tsunami, and earthquake.

### Functional Configuration of Vehicle

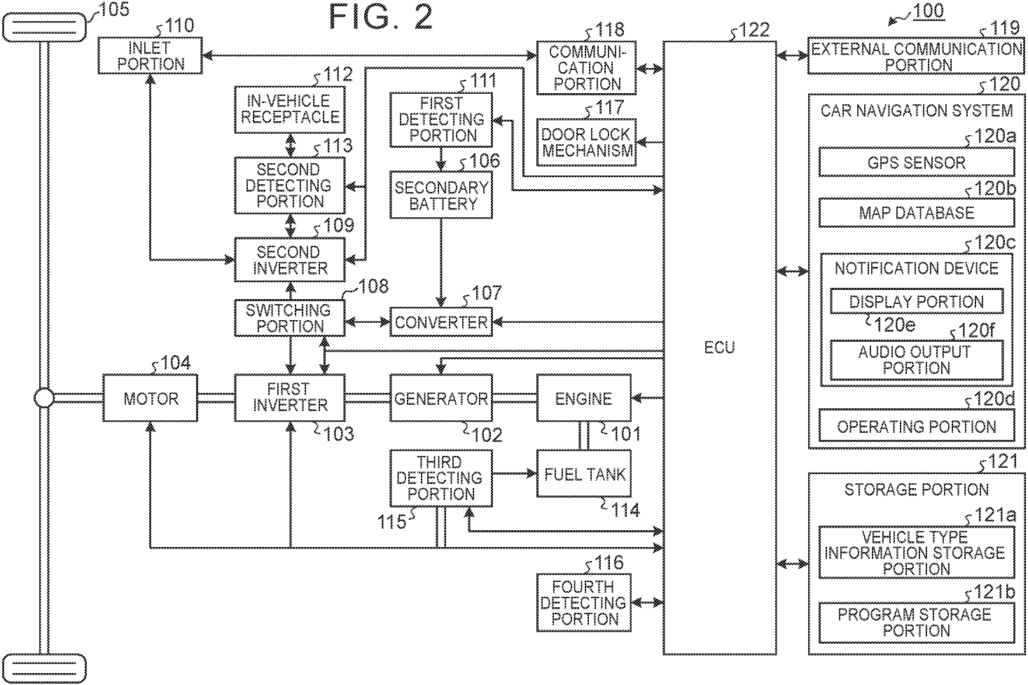

Next will be described a detailed functional configuration of the vehicle 100. FIG. 2 is a block diagram illustrating a functional configuration of the vehicle 100. As illustrated in FIG. 2, the vehicle 100 includes an engine 101, a generator 102, a first inverter 103, a motor 104, driving wheels 105, a secondary battery 106, a converter 107, a switching portion 108, a second inverter 109, an inlet portion 110, a first detecting portion 111, an in-vehicle receptacle 112, a second detecting portion 113, a fuel tank 114, a third detecting portion 115, a fourth detecting portion 116, a door lock mechanism 117, a communication portion 118, an external communication portion 119, a car navigation system 120, a storage portion 121, and an electronic control unit (ECU) 122.

The engine 101 is constituted by a well-known internal combustion engine and outputs power by use of fuel accumulated in the fuel tank 114. The engine 101 is driven under the control of the ECU 122. The power output from the engine 101 drives the generator 102.

The generator 102 is electrically connected to the motor 104 via the first inverter 103. The generator 102 supplies generated alternating current power to the secondary battery 106 via the switching portion 108 and the converter 107 under the control of the ECU 122. The generator 102 is constituted by a power-generation motor generator having a motor function in addition to a power generation function.

The first inverter 103 converts discharge electric power (direct current power) supplied from the secondary battery 106 via the switching portion 108 and the converter 107 into alternating current power and supplies the alternating current power to the motor 104, under the control of the ECU 122. Further, the first inverter 103 converts alternating current power generated by the motor 104 to direct current power at the time of regenerative braking of the vehicle 100 and supplies the direct current power to the secondary battery 106 via the switching portion 108 and the converter 107, under the control of the ECU 122. The first inverter 103 is constituted by, for example, a three-phase inverter circuit or the like including a bridge circuit including a three-phase switching element.

The motor 104 is driven by alternating current power supplied from the first inverter 103 at the time of acceleration of the vehicle 100, under the control of the ECU 122. The power output from the motor 104 drives the driving wheels 105. Further, the motor 104 functions as a generator configured to generate electric power by external force transmitted from the driving wheels 105 at the time of braking of the vehicle 100 under the control of the ECU 122 and supplies the electric power thus generated to the secondary battery 106 from the first inverter 103 via the switching portion 108 and the converter 107. The motor 104 is constituted by a driving motor generator having a power generation function in addition to a motor function.

The secondary battery 106 is constituted by a chargeable-dischargeable storage battery such as a nickel-metal hydride battery or a lithium ion battery, or a storage element such as an electric double layer capacitor, for example. The secondary battery 106 can be charged and discharged by the converter 107, and high-voltage direct current power is stored in the secondary battery 106.

A first end of the converter 107 is electrically connected to the secondary battery 106, and a second end of the converter 107 is electrically connected to either one of the first inverter 103 and the second inverter 109 via the switching portion 108. The converter 107 charges and discharges the secondary battery 106 under the control of the ECU 122. More specifically, in a case where the converter 107 charges the secondary battery 106, the converter 107 decreases the voltage of direct current power externally supplied via the second inverter 109, the inlet portion 110, and the switching portion 108 to a predetermined voltage and supplies, to the secondary battery 106, a resultant charge current with the decreased voltage. In the meantime, in a case where the converter 107 discharges the secondary battery 106, the converter 107 increases the voltage of direct current power from the secondary battery 106 and supplies a resultant discharge current with the increased voltage to the first inverter 103 via the switching portion 108.

A first end of the switching portion 108 is electrically connected to the converter 107, and a second end of the switching portion 108 is electrically connected to either one of the first inverter 103 and the second inverter 109. The switching portion 108 electrically connects the converter 107 to either one of the first inverter 103 and the second inverter 109 under the control of the ECU 122. The switching portion 108 is constituted by a mechanical relay, a semiconductor switch, or the like.

A first end of the second inverter 109 is electrically connected to the switching portion 108, and a second end of the second inverter 109 is electrically connected to the inlet portion 110 or the in-vehicle receptacle 112. The second inverter 109 converts discharge electric power (direct current power) supplied from the secondary battery 106 via the switching portion 108 and the converter 107 into alternating current power and supplies the alternating current power to the inlet portion 110, under the control of the ECU 122. More specifically, the second inverter 109 supplies alternating current power to outside via the inlet portion 110 and a charge-discharge wire (not illustrated) under the control of ECU 122. The second inverter 109 is constituted by a single-phase inverter circuit or the like so as to correspond to the type of electric power to be used outside.

A first end of the inlet portion 110 is electrically connected to the second inverter 109. The charge-discharge wire (not illustrated) is detachably connected to the inlet portion 110. The inlet portion 110 supplies alternating current power supplied from outside to the second inverter 109 via the charge-discharge wire and outputs various pieces of information including a control signal or the like input from outside to the communication portion 118. Further, the inlet portion 110 supplies alternating current power supplied from the second inverter 109 to outside via the charge-discharge wire and outputs, to outside, various pieces of information including a control signal from the ECU 122 or the like that is input via the communication portion 118.

The first detecting portion 111 detects a state of charge (SOC), a temperature, a state of health (SOH), a voltage value, and a current value of the secondary battery 106 and outputs the detection results to the ECU 122. The first detecting portion 111 is constituted by an ammeter, a voltmeter, a temperature sensor, and so on.

The in-vehicle receptacle 112 is electrically connected to the second inverter 109. A power plug of a general electric appliance is connectable to the in-vehicle receptacle 112, and the in-vehicle receptacle 112 supplies alternating current power supplied from the second inverter 109 to an electric appliance the power plug of which is connected to the in-vehicle receptacle 112.

The second detecting portion 113 is provided between the in-vehicle receptacle 112 and the second inverter 109. The second detecting portion 113 detects at least one of power consumption and a current value of electric equipment connected to the in-vehicle receptacle 112 and outputs the detection result to the ECU 122. The second detecting portion 113 is constituted by a wattmeter, an ammeter, and a voltmeter, and so on.

Fuel to be supplied to the engine 101 is accumulated in the fuel tank 114. Here, the fuel is fossil fuel such as gasoline. Note that, in a case where the vehicle 100 is an FCEV, hydrogen fuel is accumulated in the fuel tank 114.

The third detecting portion 115 detects a residual amount of the fuel accumulated in the fuel tank 114 and outputs the detection result to the ECU 122. The third detecting portion 115 is constituted by a fuel gauge or the like.

The fourth detecting portion 116 detects status information on the vehicle 100 and outputs the detection result to the ECU 122. Here, the status information is an acceleration, an inclination angle, a speed, and so on of the vehicle 100. The fourth detecting portion 116 is constituted by an acceleration sensor, a velocity sensor, a gyro sensor, and so on.

The door lock mechanism 117 opens and closes a door provided in the vehicle 100 under the control of the ECU 122.

The communication portion 118 receives a control signal including various pieces of information input from outside via the inlet portion 110 and outputs the control signal thus received to the ECU 122. Further, the communication portion 118 outputs a control signal including CAN data or the like input from the ECU 122 to the inlet portion 110. The communication portion 118 is constituted by a communications module or the like.

The external communication portion 119 transmits various pieces of information input from the ECU 122 to the communications device 200 in accordance with a predetermined communications standard under the control of the ECU 122. Further, the external communication portion 119 outputs various pieces of information received from the communications device 200 to the ECU 122. Here, the predetermined communications standard is at least one of Wi-Fi (registered trademark) and Bluetooth (registered trademark). The external communication portion 119 is constituted by a wireless communications module or the like.

The car navigation system 120 includes a global positioning system (GPS) sensor 120a, a map database 120b, a notification device 120c, and an operating portion 120d.

The GPS sensor 120a receives signals from a plurality of GPS satellites or transmitting antennas and calculates position information on the position (longitude and latitude) of the vehicle 100 based on the signals thus received. The GPS sensor 120a is constituted by a GPS reception sensor or the like. Note that, in the present embodiment, a plurality of GPS sensors 120a may be provided to improve direction accuracy of the vehicle 100.

In the map database 120b, various pieces of map information are stored. The map database 120b is constituted by a recording medium such as a hard disk drive (HDD) or a solid state drive (SSD).

The notification device 120c includes a display portion 120e on which an image, a map, a video, and text information are displayed, and an audio output portion 120f configured to output sound such as voice or warning sound. The display portion 120e is constituted by use of a display such as a liquid crystal display or an organic electroluminescence (EL) display. The audio output portion 120f is constituted by a speaker or the like.

The operating portion 120d receives operations input by a user and outputs signals corresponding to various operation contents thus received to the ECU 122. The operating portion 120d is achieved by a touchscreen, a button, a switch, a jog dial, or the like.

The car navigation system 120 configured as such superimposes position information on a present position of the vehicle 100 that is acquired by the GPS sensor 120a on a map corresponding to map data stored in the map database 120b. Hereby, the car navigation system 120 notifies the user of information including a road on which the vehicle 100 is currently traveling, a travel route to a destination, and so on, by use of the display portion 120e and the audio output portion 120f.

In the storage portion 121, various pieces of information on the vehicle 100 are stored. In the storage portion 121, CAN data on the vehicle 100 that is input from the ECU 122, various pieces of data under processing by the ECU 122, and so on are stored. The storage portion 121 includes a vehicle type information storage portion 121a in which vehicle type information on the vehicle 100 is stored, and a program storage portion 121b in which various programs to be executed by the vehicle 100 are stored. Here, the vehicle type information includes a vehicle type of the vehicle 100, identification information to identify the vehicle 100, a model year of the vehicle 100, information on whether or not power generation is performed, information indicative of any of HEV, PHEV, FCEV, and BEV, and so on. The storage portion 121 is constituted by a DRAM, a ROM, a flash memory, an SSD, or the like.

The ECU 122 is constituted by use of a memory and a processor including hardware such as a central processing unit (CPU). The ECU 122 controls operations of constituent portions constituting the vehicle 100.

### Functional Configuration of Support Server

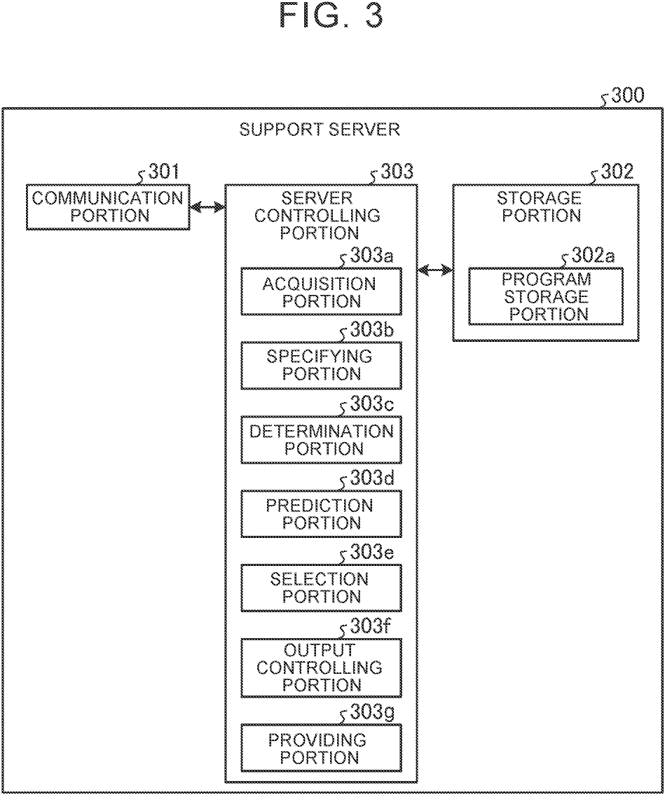

Next will be described a functional configuration of the support server 300. FIG. 3 is a block diagram illustrating the functional configuration of the support server 300. The support server 300 illustrated in FIG. 3 includes a communication portion 301, a storage portion 302, and a server controlling portion 303.

The communication portion 301 receives various pieces of information from the vehicle 100 or the communications device 200 via the network NW and also transmits various pieces of information to the vehicle 100 or the communications device 200 via the network NW, under the control of the server controlling portion 303. The communication portion 301 is constituted by a communications module or the like that can transmit and receive various pieces of information.

In the storage portion 302, various pieces of information on the support server 300 are stored. The storage portion 302 includes a program storage portion 302a in which various programs to be executed by the support server 300 are stored. The storage portion 302 is constituted by a DRAM, a ROM, a flash memory, an HDD, an SSD, or the like.

The server controlling portion 303 controls constituent portions constituting the support server 300. The server controlling portion 303 is constituted by a memory and a processor including hardware such as a CPU. The server controlling portion 303 includes an acquisition portion 303a, a specifying portion 303b, a determination portion 303c, a prediction portion 303d, a selection portion 303e, an output controlling portion 303f, and a providing portion 303g.

The acquisition portion 303a acquires a total supply power amount from each of the facilities 500 placed within the stricken area via the communication portion 301 and the network NW. The total supply power amount is obtained by adding respective supply power amounts suppliable by respective power supply vehicles 100A. Further, the acquisition portion 303a acquires, via the communication portion 301 and the network NW, respective pieces of weather information on the facilities 500 within the stricken area from the weather server 900 and respective contract demands of the facilities placed within the stricken area from the electric power management server 700. Further, the acquisition portion 303a acquires, from at least one vehicle 100 placed within the stricken area via the communication portion 301 and the network NW, a supply power amount suppliable by the vehicle 100.

The specifying portion 303b specifies, as a request facility from among the facilities 500, a facility 500 having a supply power amount less than a first threshold, based on respective supply power amounts of the facilities 500 that are acquired by the acquisition portion 303a. Here, the first threshold is an electric power amount suppliable by the power supply vehicles 100A placed in the facility 500 for an approximate period of time required until electricity is restored in the facility 500 or a period of time required until the facility 500 can obtain support of electricity (for example, for 48 hours).

The determination portion 303c determines whether or not the supply power amount suppliable by the vehicle 100 is equal to or more than a second threshold. Here, the second threshold is an electric power amount that allows the vehicle 100 to travel a predetermined distance or more (e.g., 100 km or more) by use of the secondary battery 106. Further, the determination portion 303c determines whether or not the vehicle 100 has performed power supply to the request facility, based on present position information on the vehicle 100 and facility position information on the request facility.

The prediction portion 303d predicts respective power consumptions of the facilities 500, based on the respective pieces of weather information on the facilities 500 that are acquired by the acquisition portion 303a and the respective contract demands of the facilities 500.

The selection portion 303e selects a travel route to a request facility nearest from the vehicle 100 or to a request facility having the smallest total supply power amount, based on respective residual amounts of fuel or respective SOCS of stop vehicles that are acquired by the acquisition portion 303a, respective pieces of facility position information on a plurality of request facilities specified by the specifying portion 303b, respective pieces of travel route information on travel routes usable to the request facilities, and position information on the vehicle 100.

The output controlling portion 303f outputs request facility information to at least one of the vehicle 100 and the communications device 200 associated with the vehicle 100. The request facility information is information on the request facility specified by the specifying portion 303b as a facility that requires to request power supply due to a shortage of electric power. More specifically, the output controlling portion 303f outputs request facility information including the request facility, a business type of the request facility (e.g., hospital, city hall, or the like), position information on the request facility, and a travel route in consideration of refueling or power supply from a stop vehicle.

The providing portion 303g executes a providing process of providing electronic money or points corresponding to power supply performed by the vehicle 100 to any one of a plurality of different payment methods associated with the communications device 200. The payment methods are managed by respective companies and registered in a digital wallet showing a deposit-withdrawal account for the electronic money or the points.

### Process of Support Server

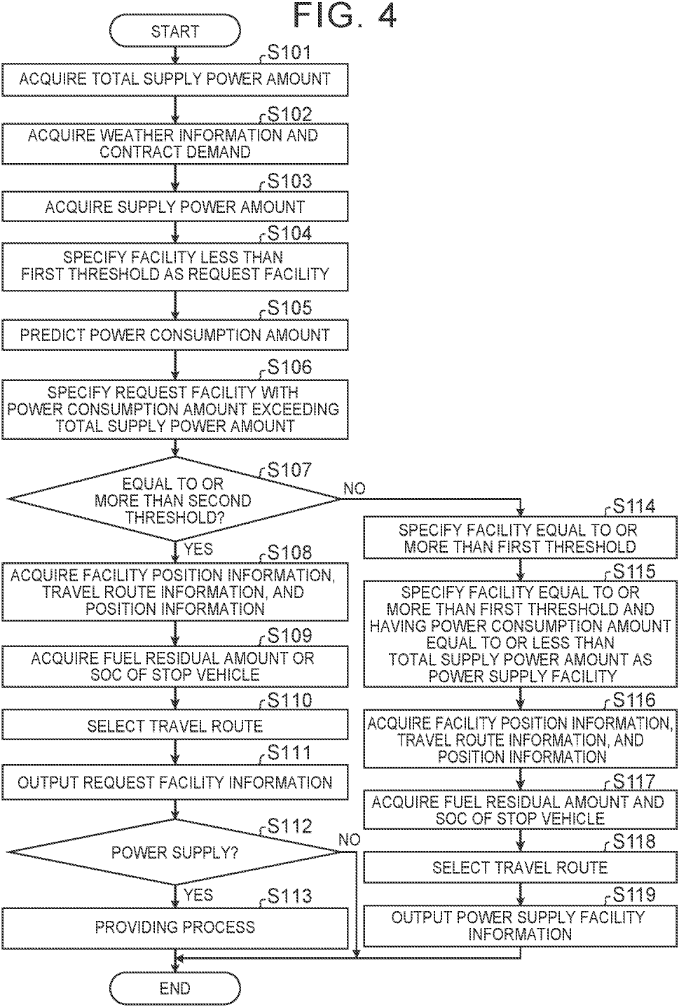

Next will be described a process to be executed by the support server 300. FIG. 4 is a flowchart illustrating the outline of the process to be executed by the support server 300.

As illustrated in FIG. 4, the acquisition portion 303a acquires, from each of the facilities 500 placed within the stricken area via the communication portion 301 and the network NW, a total supply power amount obtained by adding respective supply power amounts suppliable by the power supply vehicles 100A (step S101). In this case, the acquisition portion 303a acquired, as the total supply power amount, a resultant amount obtained by adding respective supply power amounts suppliable by the power supply vehicles 100A standing by for power supply within the facility 500 or in the vicinity of the facility 500 to a supply power amount obtained by adding respective supply power amounts suppliable by the power supply vehicles 100A electrically connected to the facility 500 via the charge-discharge apparatus 400. At this time, the acquisition portion 303a acquires, from each of the facilities 500 placed within the stricken area, respective supply power amounts suppliable by the power supply vehicles 100A standing by for power supply within the each of the facilities 500 or in the vicinity of the each of the facilities 500. Then, the acquisition portion 303a acquires, for the each of the facilities 500 placed within the stricken area, a total supply power amount by adding the respective supply power amounts suppliable by the power supply vehicles 100A standing by within the each of the facilities 500 or in the vicinity of the each of the facilities 500 to respective supply power amounts supplied by the power supply vehicles 100A that are performing power supply to the each of the facilities 500.

Subsequently, the acquisition portion 303a acquires, via the communication portion 301 and the network NW, respective pieces of weather information on the facilities 500 placed within the stricken area from the weather server 900 and respective contract demands of the facilities placed within the stricken area from the electric power management server 700 (step S102).

After that, the acquisition portion 303a acquires, from at least one vehicle 100 placed within the stricken area via the communication portion 301 and the network NW, a supply power amount suppliable by the vehicle 100 (step S103). More specifically, the acquisition portion 303a acquires the supply power amount based on the SOC of the secondary battery 106 of the vehicle 100, the residual amount of the fuel tank 114, and vehicle type information on the vehicle 100.

Subsequently, the specifying portion 303b specifies, as a request facility, a facility 500 having a supply power amount less than the first threshold from among the facilities 500, based on respective supply power amounts of the facilities 500 that are acquired by the acquisition portion 303a (step S104). Note that the first threshold can be changed appropriately. For example, the first threshold can be appropriately set in accordance with an area or the scale of a disaster. For example, the first threshold can be changed from the electric power amount suppliable for 48 hours to an electric power amount suppliable for 72 hours or an electric power amount suppliable for 24 hours.

After that, the prediction portion 303d predicts respective power consumptions of the facilities 500 based on the respective pieces of weather information on the facilities 500 that are acquired by the acquisition portion 303a and the respective contract demands of the facilities 500 (step S105). In this case, the prediction portion 303d may predict a power consumption amount to be consumed for an approximate period of time required until electricity is restored (e.g., 48 hours), based on an electric power amount used in the latest three months, other than the respective contract demands of the facilities 500.

Subsequently, the specifying portion 303b further specifies, as a request facility, a facility 500 in which the supply power amount is less than the first threshold and a power consumption amount predicted by the prediction portion 303d exceeds the total supply power amount, from among the facilities 500 (step S106).

After that, the determination portion 303c determines whether or not the supply power amount suppliable by the vehicle 100 is equal to or more than the second threshold (step S107). In a case where the determination portion 303c determines that the supply power amount suppliable by the vehicle 100 is equal to or more than the second threshold (step S107: Yes), the support server 300 shifts to step S108 (described later). In the meantime, in a case where the determination portion 303c determines that the supply power amount suppliable by the vehicle 100 is not equal to or more than the second threshold (step S107: No), the support server 300 shifts to step S114 (described later).

In step S108, the acquisition portion 303a acquires, via the communication portion 301 and the network NW, respective pieces of facility position information on the request facilities specified by the specifying portion 303b, respective pieces of travel route information on travel routes (passable roads) usable to the request facilities, and position information on the vehicle 100.

Subsequently, the acquisition portion 303a acquires, via the communication portion 301 and the network NW, respective residual amounts of fuel or respective SOCS of a plurality of stop vehicles stopping on the travel routes usable to the request facilities specified by the specifying portion 303b (step S109). In this case, only in a case where the acquisition portion 303a can communicate with the stop vehicles, the acquisition portion 303a acquires the residual amounts of fuel or the SOCS of the stop vehicles.

After that, the selection portion 303e selects a travel route usable to a request facility nearest from the vehicle 100 or to a request facility having the smallest total supply power amount, based on the respective residual amounts of fuel or the respective SOCS of the stop vehicles that are acquired by the acquisition portion 303a, the respective pieces of facility position information on the request facilities specified by the specifying portion 303b, the respective pieces of travel route information on the travel routes usable to the request facilities, and the position information on the vehicle 100 (step S110). Note that the selection portion 303e may select a travel route usable to a request facility in accordance with an emergency degree and an importance level of the request facility. Here, the emergency degree of the request facility is a value corresponding to the residual amount of the total supply power amount, and the emergency degree is higher as the value is smaller. Further, the importance level of the request facility is a value assigned to a hospital, a school, a city hall, or the like in advance, for example.

Subsequently, the output controlling portion 303f outputs request facility information to at least one of the vehicle 100 and the communications device 200 associated with the vehicle 100. The request facility information is information on a request facility specified by the specifying portion 303b as a facility that requires to request power supply due to a shortage of electric power (step S111). More specifically, the output controlling portion 303f outputs request facility information including the request facility, a business type of the request facility (e.g., hospital, city hall, or the like), position information on the request facility, and a travel route in consideration of refueling or power supply from stop vehicles.

After that, the determination portion 303c determines whether or not the vehicle 100 has performed power supply to the request facility, based on present position information on the vehicle 100 and the facility position information on the request facility (step S112). More specifically, the determination portion 303c determines whether the present position information on the vehicle 100 indicates a position included in the facility position information on the request facility. In a case where the present position information on the vehicle 100 indicates a position included in the facility position information on the request facility, the determination portion 303c determines that the vehicle 100 has performed power supply to the request facility. In a case where the determination portion 303c determines that the vehicle 100 has performed power supply to the request facility (step S112: Yes), the support server 300 shifts to step S113 (described later). In the meantime, in a case where the determination portion 303c determines that the vehicle 100 has not performed power supply to the request facility (step S112: No), the support server 300 ends this process.

In step S113, the providing portion 303g executes the providing process of providing electronic money or points corresponding to the power supply performed by the vehicle 100 to any one of the different payment methods associated with the communications device 200. The payment methods are managed by respective companies and registered in the digital wallet showing the deposit-withdrawal account for the electronic money or the points. After step S113, the support server 300 ends this process.

In step S114, the specifying portion 303b specifies, as a charging facility that can perform charging, a facility having a total supply power amount equal to or more than the first threshold from among the facilities based on respective total supply power amounts of the facilities.

Subsequently, from among a plurality of charging facilities specified in step S114, the specifying portion 303b specifies, as a power supply facility that can supply electric power to the vehicle 100, a facility 500 in which a supply power amount is equal to or more than the first threshold and a power consumption amount predicted by the prediction portion 303d is equal to or less than the total supply power amount (step S115).

After that, the acquisition portion 303a acquires respective pieces of facility position information on a plurality of power supply facilities specified by the specifying portion 303b, respective pieces of travel route information on travel routes usable to the power supply facilities, and the position information on the vehicle 100 (step S116).

Subsequently, the acquisition portion 303a acquires respective residual amounts of fuel or respective SOCS of a plurality of stop vehicles stopping on the travel routes usable to the power supply facilities specified by the specifying portion 303b (step S117).

After that, the selection portion 303e selects a travel route usable to a power supply facility nearest from the vehicle 100 or to a power supply facility having the largest total supply power amount, based on the respective residual amounts of fuel or the respective SOC of the stop vehicles that are acquired by the acquisition portion 303a, the respective pieces of facility position information on the power supply facilities specified by the specifying portion 303b, the respective pieces of travel route information on the travel routes usable to the power supply facilities, and the position information on the vehicle 100 (step S118).

Subsequently, the output controlling portion 303f outputs power supply facility information to at least one of the vehicle 100 and the communications device 200 associated with the vehicle 100 (step S119). The power supply facility information is information on a power supply facility specified by the specifying portion 303b as a facility that can perform power supply. More specifically, the output controlling portion 303f outputs power supply facility information including the power supply facility, a business type of the power supply facility (e.g., hospital, city hall, or the like), position information on the power supply facility, and a travel route in consideration of refueling or power supply from stop vehicles. After step S119, the support server 300 ends this process.

In one embodiment described above, the acquisition portion 303a acquires a total supply power amounts from each of a plurality of facilities 500 placed within a stricken area. The total supply power amount is obtained by adding respective supply power amounts of a plurality of power supply vehicles 100A that perform power supply. Further, the acquisition portion 303a acquires, from at least one vehicle 100 placed within the stricken area, a supply power amount suppliable by the vehicle 100. After that, based on respective total supply power amounts of the facilities 500 that are acquired by the acquisition portion 303a and the supply power amount of the vehicle 100, the output controlling portion 303f outputs request facility information on a request facility that requires to request power supply due to a shortage of electric power to at least one of the vehicle 100 and the communications device 200 associated with the vehicle 100. Hereby, a user of the vehicle 100 acts in accordance with the request facility information displayed on the display portion 120e of the vehicle 100 or the communications device 200, thereby making it possible to maintain a balance between necessary electric power in the facility 500 and supply electric power suppliable by the vehicle 100.

Further, in one embodiment, the specifying portion 303b specifies, as a request facility from among the facilities 500, a facility 500 having a supply power amount less than the first threshold based on respective supply power amounts of the facilities 500. Further, the determination portion 303c determines whether or not the supply power amount of the vehicle 100 is equal to or more than the second threshold. In a case where the determination portion 303c determines that the supply power amount of the vehicle 100 is equal to or more than the second threshold, the output controlling portion 303f outputs the request facility information to the vehicle 100 or the communications device 200 associated with the vehicle 100. Hereby, it is possible to request a user of a vehicle 100 with spare electric power to perform power supply by use of the vehicle 100, thereby making it possible to prevent a vehicle 100 without spare electric power from being moved to the request facility.

Further, in one embodiment, the prediction portion 303d predicts respective power consumption amounts of the facilities 500 based on weather information in the stricken area and respective contract demands of the facilities 500, and the specifying portion 303b further specifies, as a request facility from among the facilities 500, a facility 500 having a supply power amount equal to or more than the first threshold and having a power consumption amount exceeding the total supply power amount. Hereby, it is possible to guide the user of the vehicle 100 to a request facility predicted to have a shortage of the total supply power amount in consideration of an actual state in the facility 500.

Further, in one embodiment, the selection portion 303e selects a travel route usable to a request facility nearest from the vehicle 100 or to a request facility having the smallest total supply power amount, based on respective residual amounts of fuel or respective SOCS of stop vehicles that are acquired by the acquisition portion 303a, respective pieces of facility position information on a plurality of request facilities specified by the specifying portion 303b, respective pieces of travel route information on travel routes usable to the request facilities, and position information on the vehicle 100. Then, the output controlling portion 303f outputs, to the vehicle 100 or the communications device 200 associated with the vehicle 100, request facility information including the travel route and facility position information on the request facility nearest from the vehicle 100 or the request facility having the smallest total supply power amount. Hereby, the user of the vehicle 100 can grasp the position of the request facility that requests power supply while the user checks the travel route.

Further, in one embodiment, the selection portion 303e selects a travel route based on the respective residual amounts of fuel of the stop vehicles or the respective SOC of the stop vehicles, the respective pieces of facility position information, the respective pieces of travel route information, and the position information on the vehicle 100. Hereby, the user of the vehicle 100 can grasp the travel route to the request facility while the user refuels or charges the vehicle 100.

Further, in one embodiment, in a case where the determination portion 303c determines that the vehicle 100 has performed power supply to the request facility, the providing portion 303g executes the providing process of providing electronic money or points corresponding to the power supply performed by the vehicle 100 to any one of the different payment methods associated with the communications device 200. The payment methods are managed by respective companies and registered in the digital wallet showing the deposit-withdrawal account for the electronic money or the points. Hereby, the user of the vehicle 100 can obtain points or electronic money by performing power supply.

Further, in one embodiment, in a case where the determination portion 303c determines that the supply power amount of the vehicle 100 is not equal to or more than the second threshold, the output controlling portion 303f outputs, to the vehicle 100 or the communications device 200 associated with the vehicle 100, charge information on a charging facility specified by the specifying portion 303b as a facility where the vehicle 100 can be charged. Hereby, the user of the vehicle 100 can grasp a power supply facility that can supply electric power to the vehicle 100.

Note that, in one embodiment, the support server 300 acquires various pieces of information via the network NW, but the vehicle 100 may acquire various pieces of information by vehicle-to-vehicle communication, for example. In this case, the support server 300 may cause a vehicle 100 controllable or communicable via the network NW to acquire various pieces of information by performing vehicle-to-vehicle communication with other vehicles or power supply vehicles 100A, and the support server 300 may acquire the various pieces of information from the vehicle 100.

Further, in one embodiment, a request facility is specified based on respective total supply power amounts in a plurality of facilities. However, a request facility may be specified in response to a request on fossil fuel such as gasoline, relief supplies, or the like.

Further, in one embodiment, the “portion” mentioned above can be regarded as a “circuit” or the like. For example, the controlling portion can be regarded as a control circuit.

Further, the program to be executed by the disaster support system according to one embodiment is provided by being recorded in a recording medium readable by a computer, e.g., a CD-ROM, a flexible disk (FD), a CD-R, a digital versatile disk (DVD), a USB medium, or a flash memory, as file data in an installable or executable manner.

Further, the program to be executed by the disaster support system according to one embodiment may be stored in a computer connected to a network such as the Internet and provided by downloading via the network.

Note that, in the description about the flowcharts in the present specification, the context of processes of steps is exhibited by use of expressions such as “first,” “after that,” and “subsequently.” However, the order of processes necessary to carry out the embodiment is not determined uniquely by those expressions. That is, the order of the processes in the flowcharts described in the present specifications can be changed within a consistent range.

Further effects and modifications can be easily derived by a person skilled in the art. A wider variety of aspects of the disclosure are not limited to specific details and representative embodiments expressed and described above. Accordingly, various changes can be made without departing from the spirit or scope of a general concept of the disclosure defined by attached claims and their equivalents.

What is claimed is:

1. A support server comprising a processor configured to:
acquire a total supply power amount from each of a plurality of facilities placed within a stricken area, the total supply power amount being obtained by adding respective supply power amounts of a plurality of power supply vehicles configured to perform power supply;
acquire, from at least one vehicle placed within the stricken area, a supply power amount suppliable by the at least one vehicle; and
output, to at least either one of the at least one vehicle and a communications device associated with the at least one vehicle, request facility information on a request facility that requires to request power supply due to a shortage of electric power, based on respective total supply power amounts of the facilities and the supply power amount suppliable by the at least one vehicle.

2. The support server according to claim 1, wherein:
the processor specifies, as the request facility from among the facilities, a facility having a supply power amount less than a first threshold, based on respective supply power amounts of the facilities;
the processor determines whether or not the supply power amount suppliable by the at least one vehicle is equal to or more than a second threshold; and
the processor outputs the request facility information in a case where the processor determines that the supply power amount suppliable by the at least one vehicle is the second threshold or more.

3. The support server according to claim 2, wherein:
the processor acquires respective pieces of weather information on the facilities and respective contract demands of the facilities;
the processor predicts respective power consumption amounts of the facilities based on the respective pieces of weather information and the respective contract demands; and
the processor further specifies, as the request facility from among the facilities, a facility having a supply power amount equal to or more than the first threshold and having a power consumption amount exceeding the total supply power amount.

4. The support server according to claim 1, wherein:
the processor acquires respective pieces of facility position information on a plurality of request facilities, respective pieces of travel route information on travel routes usable to the request facilities, and position information on the at least one vehicle;
the processor selects a travel route usable to a request facility nearest from the at least one vehicle or a request facility having a smallest total supply power amount based on the respective pieces of facility position information, the respective pieces of travel route information, and the position information; and
the processor outputs request facility information including the travel route thus selected and facility position information on the request facility nearest from the at least one vehicle or the request facility having the smallest total supply power amount.

5. The support server according to claim 4, wherein:
the processor acquires respective residual amounts of fuel in respective fuel tanks of a plurality of stop vehicles stopping on the travel routes usable to the request facilities or respective states of charge of respective secondary batteries of the stop vehicles; and
the processor selects the travel route based on the respective residual amounts of fuel of the stop vehicles or the respective states of charge of the stop vehicles, the respective pieces of facility position information, the respective pieces of travel route information, and the position information.

6. The support server according to claim 1, wherein:
the processor is configured to determine whether or not the at least one vehicle has performed power supply to the request facility; and
in a case where the processor determines that the at least one vehicle has performed power supply to the request facility, the processor executes a providing process of providing electronic money or points corresponding to a supply power amount supplied by the at least one vehicle to any one of a plurality of different payment methods associated with the communications device, the different payment methods being managed by respective companies and registered in a digital wallet showing a deposit-withdrawal account for the electronic money or the points.

7. The support server according to claim 2, wherein:
the processor specifies, as a charging facility where charging is performable, a facility having a total supply power amount equal to or more than the first threshold from among the facilities, based on the respective total supply power amounts of the facilities; and
the processor outputs charge information on the charging facility in a case where the processor determines that the supply power amount suppliable by the at least one vehicle is not the second threshold or more.

8. A disaster support system comprising:
a plurality of power supply vehicles configured to perform power supply to each of a plurality of facilities within a stricken area;
at least one vehicle placed within the stricken area; and
a support server communicable with each of the power supply vehicles and the at least one vehicle, wherein the support server includes a processor configured to
acquire a total supply power amount from each of the facilities, the total supply power amount being obtained by adding respective supply power amounts of the power supply vehicles,
acquire, from the at least one vehicle, a supply power amount suppliable by the at least one vehicle, and
output, to at least either one of the at least one vehicle and a communications device associated with the at least one vehicle, request facility information on a request facility that requires to request power supply due to a shortage of electric power, based on respective total supply power amounts of the facilities and the supply power amount suppliable by the at least one vehicle.

9. A non-transitory storage medium storing a program that causes a support server to execute the followings:
acquiring a total supply power amount from each of a plurality of facilities placed within a stricken area, the total supply power amount being obtained by adding respective supply power amounts of a plurality of power supply vehicles configured to perform power supply;
acquiring, from at least one vehicle placed within the stricken area, a supply power amount suppliable by the at least one vehicle; and
outputting, to at least either one of the at least one vehicle and a communications device associated with the at least one vehicle, request facility information on a request facility that requires to request power supply due to a shortage of electric power, based on respective total supply power amounts of the facilities and the supply power amount suppliable by the at least one vehicle.
